(19) United States
(12) Patent Application Publication
(10) Pub. No.: US 2022/0209292 A1
(43) Pub. Date: Jun. 30, 2022

(54) LITHIUM ION SECONDARY BATTERY AND MANUFACTURING METHOD THEREFOR, AND SOLID ELECTROLYTE MEMBRANE FOR LITHIUM ION SECONDARY BATTERY AND MANUFACTURING METHOD THEREFOR

(71) Applicant: FUJIFILM Corporation, Tokyo (JP)

(72) Inventor: Shinji IMAI, Kanagawa (JP)

(73) Assignee: FUJIFILM Corporation, Tokyo (JP)

(21) Appl. No.: 17/699,183

(22) Filed: Mar. 21, 2022

Related U.S. Application Data
(63) Continuation of application No. PCT/JP2020/040486, filed on Oct. 28, 2020.

(30) Foreign Application Priority Data
Oct. 30, 2019 (JP) 2019-197748

(51) Int. Cl. H01M 10/0562; H01M 10/0525; H01M 4/04; H01M 4/38

(52) U.S. Cl. CPC H01M 10/0562; H01M 10/0525; H01M 2004/027; H01M 4/382; H01M 4/0407

(57) ABSTRACT

There are provided a lithium ion secondary battery and a manufacturing method thereof, including a solid electrolyte membrane having an electron-insulating inorganic particle having a particle diameter of 10 to 500 nm, an inorganic solid electrolyte particle larger than the electron-insulating inorganic particle and having electrolytic solution resistance and ion conductivity, and a thermofused solidified product of an electron-insulating material and thermofuses in a specific temperature region, with which a void between the solid particles is filled; a positive electrode layer; a negative electrode layer, where thermofused solidified product of an electron-insulating material is in an amorphous state, and in the solid electrolyte membrane, the inorganic solid electrolyte particles are disposed substantially in a single layer. There are also provided a solid electrolyte membrane suitable as a separator of this battery, and a manufacturing method therefor.

### CROSS-REFERENCE TO RELATED APPLICATIONS

This application is a Continuation of PCT International Application No. PCT/JP2020/040486 filed on Oct. 28, 2020, which claims priority under 35 U.S.C. § 119 (a) to Japanese Patent Application No. 2019-197748 filed in Japan on Oct. 30, 2019. Each of the above applications is hereby expressly incorporated by reference, in its entirety, into the present application.

### BACKGROUND OF THE INVENTION

### 1. Field of the Invention

The present invention relates to a lithium ion secondary battery and a manufacturing method therefor. The present invention also relates to a solid electrolyte membrane for a lithium ion secondary battery and a manufacturing method therefor.

### 2. Description of the Related Art

A lithium ion secondary battery is a storage battery which has a negative electrode, a positive electrode, and an electrolyte sandwiched between the negative electrode and the positive electrode and enables charging and discharging by reciprocal migration of lithium ions between both electrodes. An organic electrolytic solution has been conventionally used in a lithium ion secondary battery as an electrolyte. Furthermore, in order to further improve reliability and safety, the development of an all-solid state secondary battery using a nonflammable inorganic solid electrolyte instead of the organic electrolytic solution is underway. In all-solid state secondary batteries, all of the negative electrode, the electrolyte, and the positive electrode are solid, safety and reliability which are considered as a problem of batteries in which the organic electrolytic solution is used can be significantly improved, and it also becomes possible to extend the service lives.

In lithium ion secondary batteries, during charging, electrons migrate from the positive electrode to the negative electrode, at the same time, lithium ions are released from a lithium oxide or the like that constitutes the positive electrode, and these lithium ions reach the negative electrode through the electrolyte and are accumulated in the negative electrode. As described above, there is a phenomenon in which some of the lithium ions accumulated in the negative electrode capture electrons and are precipitated as metallic lithium. In a case where this metallic lithium precipitate grows in a dendrite shape due to repeated charging and discharging, the lithium metal precipitate eventually reaches the positive electrode. As a result, an internal short circuit or the like occurs, and thus a function as a secondary battery is lost. This dendrite (Li dendrite) is very fine, which becomes a problem not only in a lithium ion secondary battery using an organic electrolytic solution but also in an all-solid state secondary battery using a solid as an electrolyte. That is, the Li dendrite can pass through these voids and grow even in a case where the voids are small voids between solid particles that constitute a solid electrolyte layer, such as cracks and pinholes generated in the solid electrolyte layer.

In order to deal with the problem of internal short circuit due to dendrites, WO2018/164051A describes that a thermofused product of an electron-insulating material such as such or modified sulfur is caused to spread into voids between inorganic solid electrolyte materials, the voids being formed in a case where a solid electrolyte layer of an all-solid state secondary battery is formed of an inorganic solid electrolyte material, by utilizing the capillary action, and then cooled to solidify thermofused product, and that this makes it possible for the voids between the inorganic solid electrolyte materials to be filled with a thermofused solidified product of the electron-insulating material, whereby the dendrite blocking function due to the solid electrolyte layer can be enhanced.

### SUMMARY OF THE INVENTION

According to the technology described in WO2018/164051A, it is said that voids between solid particles of a solid electrolyte layer can be filled with an electron-insulating material without gaps, whereby the growth of Li dendrites is blocked, and it is possible to obtain an all-solid state secondary battery having excellent charging and discharging cycle characteristics.

As a result of further studies on the technology described in WO2018/164051A, the inventors of the present invention have found that although this technology can effectively suppress an internal short circuit due to the growth of Li dendrites, the battery tends to have a high resistance. The reason for this is not clear; however, it is conceived that the electron-insulating material with which the voids between the inorganic solid electrolyte particles are filled acts in an inhibitory manner on the lithium ion between the inorganic solid electrolyte particles connected in the thickness direction.

An object of the present invention is to provide a lithium ion secondary battery having excellent charging and discharging cycle characteristics and also having an excellent ion conductivity, and a manufacturing method therefor.

In addition, another object of the present invention is to provide a solid electrolyte membrane which makes it possible for a lithium ion secondary battery to be obtained to be excellent in charging and discharging cycle characteristics and to be excellent in ion conductivity by using a positive/negative electrode separating membrane (a separator) that insulates spaces between the positive and negative electrodes of the lithium ion secondary battery, and to provide a manufacturing method therefor.

The above-described objects of the present invention have been achieved by the following means.

[1] A lithium ion secondary battery comprising:

a solid electrolyte membrane having an electron-insulating inorganic particle having a particle diameter of 10 to 500 nm, an inorganic solid electrolyte particle having a particle diameter larger than a particle diameter of the electron-insulating inorganic particle and having electrolytic solution resistance and ion conductivity, and a thermofused solidified product of an electron-insulating material that is solid at 100° C. and thermofuses in a temperature region of 200° C. or lower, with which a void between the solid particles is filled;

a positive electrode layer disposed on one side of the solid electrolyte membrane;

a negative electrode layer disposed on a side of the solid electrolyte membrane opposite to the one side, where the positive electrode layer is disposed; and

in which the thermofused solidified product of the electron-insulating material is in an amorphous state, and

a thickness of the solid electrolyte membrane is equal to or larger than [a particle diameter of the inorganic solid electrolyte particle×0.7] and equal to or smaller than [the particle diameter of the inorganic solid electrolyte particle×1.3].

[2] The lithium ion secondary battery according to [1], in which a positive electrode active material layer that constitutes the positive electrode layer contains an electrolytic solution, and the thickness of the positive electrode active material layer is 200 to 2,000 μm.

[3] The lithium ion secondary battery according to [1] or [2], in which a negative electrode active material that constitutes the negative electrode layer contains metallic lithium.

[4] The lithium ion secondary battery according to any one of [1] to [3], in which the entire negative electrode layer is constituted of a metallic lithium layer and has a sulfide-based inorganic solid electrolyte layer between the metallic lithium layer and the solid electrolyte membrane.

[5] The lithium ion secondary battery according to [1] or [2], in which a negative electrode active material layer that constitutes the negative electrode layer contains an electrolytic solution.

[6] The lithium ion secondary battery according to [1], in which the lithium ion secondary battery is an all-solid state lithium ion secondary battery.

[7] The lithium ion secondary battery according to any one of [1] to [7], in which the electron-insulating material contains sulfur.

[8] The lithium ion secondary battery according to [7], in which the electron-insulating material is at least one of sulfur or modified sulfur.

[9] The lithium ion secondary battery according to any one of [1] to [8], in which the particle diameter of the electron-insulating inorganic particle and the particle diameter of the inorganic solid electrolyte particle satisfy the following formula, 5≤[the particle diameter of the inorganic solid electrolyte particle]/[the particle diameter of the electron-insulating inorganic particle].

[10] A solid electrolyte membrane for a lithium ion secondary battery, comprising:

an electron-insulating inorganic particle having a particle diameter of 10 to 500 nm;

an inorganic solid electrolyte particle having a particle diameter larger than a particle diameter of the electron-insulating inorganic particle and having electrolytic solution resistance and ion conductivity; and

a thermofused solidified product of an electron-insulating material that is solid at 100° C. and thermofuses in a temperature region of 200° C. or lower, with which a void between the solid particles is filled,

in which the thermofused solidified product of the electron-insulating material is in an amorphous state, and

a thickness of the solid electrolyte membrane is equal to or larger than [the particle diameter of the inorganic solid electrolyte particle×0.7] and equal to or smaller than [the particle diameter of the inorganic solid electrolyte particle×1.3].

[11] The solid electrolyte membrane for a lithium ion secondary battery according to [10], in which the electron-insulating material contains sulfur.

[12] The solid electrolyte membrane for a lithium ion secondary battery according to [11], in which the electron-insulating material is at least one of sulfur or modified sulfur.

[13] A manufacturing method for the solid electrolyte membrane for a lithium ion secondary battery according to [10] to [12], the manufacturing method comprising:

forming a layer, in which the electron-insulating material thermofuses, using a composition containing an electron-insulating inorganic particle having a particle diameter of 10 to 500 nm, an inorganic solid electrolyte particle having a particle diameter larger than a particle diameter of the electron-insulating inorganic particle and having electrolytic solution resistance and Li ion conductivity; and the electron-insulating material that is solid at 100° C. and thermofuses in a temperature region of 200° C. or lower; and

solidifying a thermofused product of the electron-insulating material under a pressure of 100 MPa or more.

[14] A manufacturing method for a lithium ion secondary battery, comprising disposing the solid electrolyte membrane for a lithium ion secondary battery according to any one of [10] to [12] between a positive electrode and a negative electrode.

In the present specification, numerical ranges expressed using “to” include numerical values before and after the “to” as the lower limit value and the upper limit value.

The lithium ion secondary battery according to an aspect of the present invention is excellent in charging and discharging cycle characteristics and also excellent in ion conductivity. In addition, according to the solid electrolyte membrane for a lithium ion secondary battery according to an aspect of the present invention, it is possible to provide a solid electrolyte membrane which makes it possible for a lithium ion secondary battery to be obtained to be excellent in charging and discharging cycle characteristics and to be excellent in ion conductivity by using a positive/negative electrode separating membrane (a separator) that insulates spaces between the positive and negative electrodes of the lithium ion secondary battery.

Further, according to the manufacturing method for a lithium ion secondary battery according to an aspect of the present invention, it is possible to obtain a lithium ion secondary battery having excellent charging and discharging cycle characteristics and excellent ionic conductivity. Furthermore, according to the manufacturing method for a solid electrolyte membrane for a lithium ion secondary battery according to the aspect of the present invention, it is possible to provide a solid electrolyte membrane which makes it possible for a lithium ion secondary battery to be obtained to be excellent in charging and discharging cycle characteristics and to be excellent in ion conductivity by using a positive/negative electrode separating membrane (a separator) that insulates spaces between the positive and negative electrodes of the lithium ion secondary battery.

### BRIEF DESCRIPTION OF THE DRAWINGS

FIG. 1 is a vertical cross-sectional view schematically illustrating a basic structure of an all-solid state lithium ion secondary battery, which is one embodiment of a lithium ion secondary battery.

FIG. 2 is a vertical cross-sectional view schematically illustrating a preferred lamination form of the lithium ion secondary battery of the present invention.

FIG. 3 is a vertical cross-sectional view schematically illustrating another preferred lamination form of the lithium ion secondary battery of the present invention.

FIG. 4 is a vertical cross-sectional view schematically illustrating another preferred lamination form of the lithium ion secondary battery of the present invention.

FIG. 5 is a vertical cross-sectional view schematically illustrating another preferred lamination form of the lithium ion secondary battery of the present invention.

FIG. 6 is a vertical cross-sectional view schematically illustrating another preferred lamination form of the lithium ion secondary battery of the present invention.

FIG. 7 is a vertical cross-sectional view schematically illustrating another preferred lamination form of the lithium ion secondary battery of the present invention.

### DESCRIPTION OF THE PREFERRED EMBODIMENTS

[Lithium Ion Secondary Battery]

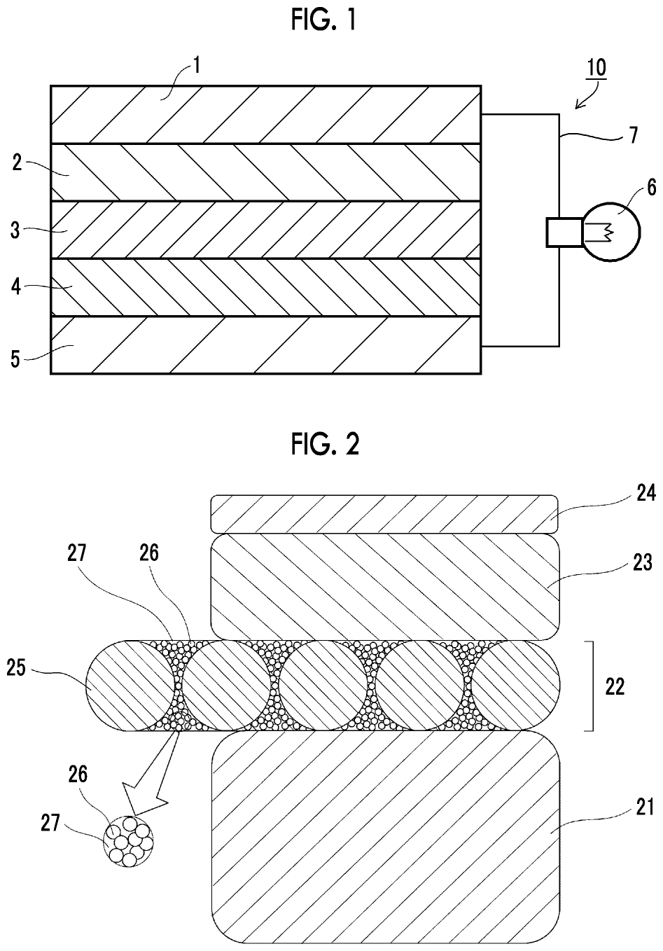

First, the operating mechanism of a general lithium ion (Li ion) secondary battery will be described by taking the form of the all-solid state Li ion secondary battery illustrated in FIG. 1 as an example. FIG. 1 is a cross-sectional view schematically illustrating a general layer constitution of an all-solid state Li ion secondary battery, which is one form of a Li ion secondary battery. An all-solid state Li ion secondary battery 10 illustrated in FIG. 1 has a structure obtained by laminating, in the following order in a case of being viewed from the negative electrode side, a negative electrode collector 1, a negative electrode active material layer 2 (the negative electrode collector 1 and the negative electrode active material layer 2 are collectively referred to as a negative electrode layer), a solid electrolyte layer 3, a positive electrode active material layer 4, and a positive electrode collector 5 (the positive electrode active material layer 4 and the positive electrode collector 5 are collectively referred to as a positive electrode layer), where adjacent layers are in direct contact with each other. In a case where such a structure is employed, during charging, electrons (e) are supplied from the positive electrode side to the negative electrode side through a circuit wire 7, Li ions are released from the positive electrode active material layer 4, these Li ions pass through the solid electrolyte layer 3 (Li ion conduction) to move to the negative electrode side, and become accumulated in the negative electrode active material layer 2.

On the other hand, during discharging, Li ions accumulated in the negative electrode active material layer 2 are released, these Li ions pass through the solid electrolyte layer 3 and are returned to the positive electrode side, and become accumulated in the positive electrode active material layer 4. At this time, electrons move from the negative electrode side to the positive electrode side through the circuit wire 7, whereby the electrons are supplied to an operation portion 6. In the all-solid state Li ion secondary battery 10 exemplarily illustrated in the drawing, an electric bulb is employed as the operation portion 6, and it is configured to lit by discharging.

Further, the all-solid state Li ion secondary battery can have a form in which the solid electrolyte layer 3 and the negative electrode collector 1 are in direct contact with each other without having the negative electrode active material layer 2. The all-solid state Li ion secondary battery having this form utilizes a phenomenon in which a part of Li ions accumulated in the negative electrode during charging are bounded to electrons and then precipitated as metallic lithium (metallic Li) on the surface of the negative electrode collector. That is, the all-solid state secondary battery having this form causes the metallic Li precipitated on the surface of the negative electrode to function as a negative electrode active material layer. For example, metallic Li is conceived to have a theoretical capacity larger than the graphite that is widely used as a negative electrode active material, by 10 times or more. As a result, in a case where the metallic Li is precipitated on the negative electrode to obtain a form in which a solid electrolyte layer is pushed to be held to the precipitated metallic Li, a metallic lithium layer can be formed on the collector surface, whereby a secondary battery having a high energy density can be realized.

Further, in the all-solid state secondary battery in which the negative electrode active material layer is removed, the thickness of the battery becomes thin, and thus in a case where the battery is wound in a roll shape, cracking in the solid electrolyte layer occurs. There is also an advantage that it becomes possible to further suppress.

In the present specification, the all-solid state Li ion secondary battery having a form in which a negative electrode active material layer is not included means that a negative electrode active material layer is not formed in the layer forming step in battery manufacturing; however, a negative electrode active material layer is formed between the solid electrolyte layer and the negative electrode collector by charging (repeating of charging and discharging) as described above.

Further, the all-solid state Li ion secondary battery can have a form in which both functions of the negative electrode collector and the negative electrode active material layer are imparted to a layer of metallic lithium such as a lithium foil. That is, the negative electrode layer can be made to be one layer of the metallic lithium layer.

In the above description, the layer constitution and the operating mechanism of the general Li ion secondary battery have been described by taking an all-solid state Li secondary battery as an example. In the above-described form, the solid electrolyte layer 3 has a Li ion conductivity and functions as a positive/negative electrode separating membrane (a separator) that insulates spaces between the positive and negative electrodes of the Li ion secondary battery.

Subsequently, a preferred embodiment of the Li ion secondary battery of the present invention will be described.

The Li ion secondary battery according to the embodiment of the present invention is characterized by the structure of the separator. That is, the Li ion secondary battery according to the embodiment of the present invention employs as a separator a solid electrolyte membrane having a specific constitution.

Here, the Li ion secondary battery according to the embodiment of the present invention is not limited to the all-solid state Li ion secondary battery as long as the form thereof is a form in which a solid electrolyte membrane constituted by combining specific materials specified in the present invention and having a specific thickness specified in the present invention is employed as a separator, and it may be a Li ion secondary battery using an electrolytic solution (an electrolytic solution-type Li ion secondary battery). In the present invention, the “electrolyte solution-type Li ion secondary battery” broadly includes a secondary battery using an electrolytic solution. For example, “the electrolytic solution-type secondary battery” according to the embodiment of the present invention also includes a so-called semi-solid state battery in which an electrolytic solution, an electrode active material (a positive electrode active material or a negative electrode active material), and the like are mixed to prepare a viscous slurry, this slurry is thickly applied to form a semi-solid state shape electrode active material layer (a positive electrode active material layer or a negative electrode active material layer). The formation of such a semi-solid state electrode itself is known, and for example, JP2016-511521A can be referred to. The semi-solid state shape electrode active material layer can be thickened, which is advantageous in increasing the energy density of the battery. The thickness of the semi-solid state shape electrode active material layer can be, for example, about 200 to 2,000 μm.

Further, in the Li ion secondary battery according to the embodiment of the present invention, it is also preferable that one of the positive electrode active material layer and the negative electrode active material layer has a form containing an electrolytic solution (preferably a semi-solid state electrode), and the other thereof has a form not containing an electrolytic solution (an all-solid state electrode).

Further, as the form that contains a positive electrode active material layer as an electrolytic solution, it is possible to adopt a form in which a negative electrode active material layer is not provided. In this case, as described above, it is possible to adopt a form in which a negative electrode active material layer is formed between the solid electrolyte layer and the negative electrode collector by charging. In addition, it is also preferable that the negative electrode layer is constituted of metallic Li.

Each material, an electrolytic solution, a component composition or lamination constitution of a layer, a member, and a manufacturing method for a Li ion secondary battery, which are used in the Li ion secondary battery according to the embodiment of the present invention, are not particularly limited except for the constitution of the solid electrolyte membrane that is used as a separator. As this material, electrolytic solution, member, and the like, those that are used for a general Li ion secondary battery can be appropriately applied. Further, as the manufacturing method for a Li ion secondary battery according to the embodiment of the present invention, a general method can be appropriately employed except for the constitution of the solid electrolyte membrane used as the separator. For example, WO2018/164051A, JP2016-201308A, JP2019-12688A, and the like can be appropriately referred to.

The solid electrolyte membrane, which is a characteristic constitution of the Li ion secondary battery according to the embodiment of the present invention, will be described below. Hereinafter, this solid electrolyte membrane is also referred to as “the solid electrolyte membrane according to the embodiment of the present invention”.

<Solid Electrolyte Membrane (Separator)>

One form of the solid electrolyte membrane according to the embodiment of the present invention includes an electron-insulating inorganic particle, an inorganic solid electrolyte particle having both electrolytic solution resistance and Li ion conductivity, and a thermofused solidified product of an electron-insulating material of which the thermofusion temperature is within a specific range and with which voids between the solid particles is filled.

It is preferable that the “electron-insulating inorganic particles”, the “inorganic solid electrolyte particles”, and the “electron-insulating material”, which are contained in the solid electrolyte membrane according to the embodiment of the present invention are constituted of materials different from each other.

The particle diameter of the “electron-insulating inorganic particle” contained in the solid electrolyte membrane according to the embodiment of the present invention is 10 to 500 nm, and the particle diameter of the “inorganic solid electrolyte particle” is larger than the particle diameter of the “electron-insulating inorganic particle”.

The thickness of the solid electrolyte membrane according to the embodiment of the present invention is equal to or larger than [the particle diameter of the inorganic solid electrolyte particle×0.7] and equal to or smaller than [the particle diameter of the inorganic solid electrolyte particle×1.3]. That is, in the solid electrolyte membrane according to the embodiment of the present invention, the inorganic solid electrolyte particles are disposed substantially in a single layer (one layer) in the plane direction. As a result, in the Li ion secondary battery in which the solid electrolyte layer is disposed as a separator, the Li ion conduction in the thickness direction of the solid electrolyte layer can be completed by the ion conduction in the single particle. For this reason, the resistance of the battery can be suppressed to be low.

Further, the solid electrolyte membrane according to the embodiment of the present invention is in a state where the voids between the solid particles of the inorganic solid electrolyte particles are filled with the electron-insulating inorganic particles having a smaller particle diameter than the inorganic solid electrolyte particles and thermofused solidified product of the electron-insulating material. As a result, although it is a solid electrolyte membrane in which the inorganic solid electrolyte particles are a thin layer in which the inorganic solid electrolyte particles are disposed substantially in a single layer (one layer) in the plane direction, the growth of Li dendrite can be sufficiently suppressed by using it as a separator of a Li ion secondary battery, and thus it is possible to provide a Li ion secondary battery having excellent charging and discharging cycle characteristics as well.

The material for forming the solid electrolyte membrane according to the embodiment of the present invention will be described in order.

—Electron-Insulating Inorganic Particle—

The electron-insulating inorganic particles contained in the solid electrolyte membrane according to the embodiment of the present invention have a particle diameter of 10 to 500 nm, which is smaller than the inorganic solid electrolyte particles. As a result, the electron-insulating inorganic particles can enter the voids between the inorganic solid electrolytes. Further, in a case where the above-described electron-insulating material is caused to thermofuse in a state where the electron-insulating inorganic particles have entered the voids between the inorganic solid electrolytes, thermofused product easily moves to the voids between the solid particles due to the capillary action, whereby it is possible to sufficiently fill the voids between the solid particles with thermofused product of the electron-insulating material without gaps. Furthermore, in a case where thermofused product is cooled (in a case where it is released from the heated state), the electron-insulating inorganic particles limit the movement of thermofused product by the cohesive force thereof or the like, whereby it is possible to suppress the crystallization of thermofused product (maintain a predetermined amorphous state). That is, it is also possible to suppress the generation of slight pores through which Li dendrites can penetrate in the solidified product (thermofused solidified product) that is obtained by cooling after thermofusion. In a case where thermofusion and solidification of the electron-insulating material are carried out under high pressure (for example, 100 MPa or more, preferably 140 MPa or more, more preferably 160 MPa or more, and still more preferably 200 MPa or more, and generally 1,000 MPa or less), thermofused product can be solidified while maintaining a better amorphous state. It is noted that the electron-insulating inorganic particles themselves have an action of blocking the growth of dendrites.

Electron-insulating inorganic particles usually do not have a lithium ion conductivity. In the solid electrolyte membrane according to the embodiment of the present invention, it is substantially inorganic solid electrolyte particles that are responsible for the Li ion conductivity. However, the electron-insulating inorganic particles may have a lithium ion conductivity as long as the effects of the present invention are not impaired. That is, in a case where the electron-insulating inorganic particles have a particle diameter of 10 to 500 nm, they may have a Li ion conductivity, and their cohesive force suppresses crystallization during the solidification of thermofused product. In a case where the electron-insulating inorganic particles and the inorganic solid electrolyte particles have the same composition, the slurry solvent can be easily selected, and thus the cost can be reduced.

In the present specification, the term “solid particle” in the solid electrolyte membrane is used to refer to both of the inorganic solid electrolyte particle and the electron-insulating inorganic particle.

In the present invention, the fact that “thermofused solidified product of the electron-insulating material is in an amorphous state” can be determined by Raman microscope spectroscopy. Specifically, it is possible to determine whether or not a sample is in an amorphous state by observing the sample surface with a resolution of 3 μm using a Raman microscope spectroscopy apparatus. For example, in a case where Raman shift is detected using sulfur as the electron-insulating material, crystalline sulfur has a peak in a bandwidth of 3.8 to 4.0 cm⁻¹; however, amorphous sulfur has a peak in a bandwidth of 4.5 to 5.2 cm⁻¹. As a result, in a case where sulfur has a peak in a bandwidth of 4.5 to 5.2 cm⁻¹ in terms of Raman shift, it can be determined to be in an amorphous state. Similarly, in a case where the electron-insulating material is other than sulfur, it is possible to determine whether or not it is in an amorphous state by examining in advance the bandwidth in which the peak is present in the crystalline state and the bandwidth in which the peak is present in the amorphous state.

The particle diameter of the electron-insulating inorganic particles is preferably 15 to 400 nm, more preferably 20 to 300 nm, still more preferably 20 to 200 nm, still more preferably 25 to 150 nm, and particularly preferably 25 to 100 nm.

The relationship between the particle diameter of the electron-insulating inorganic particle and the particle diameter of the inorganic solid electrolyte particle described in detail later preferably satisfies [particle diameter of inorganic solid electrolyte particle]/[particle diameter of electron-insulating inorganic particle]≥5, and more preferably [particle diameter of inorganic solid electrolyte particle]/[particle diameter of electron-insulating inorganic particle]≥10.

The relationship between the particle diameter of the electron-insulating inorganic particle and the particle diameter of the inorganic solid electrolyte particle preferably satisfies,

preferably 5≤[the particle diameter of the inorganic solid electrolyte particle]/[the particle diameter of the electron-insulating inorganic particle]≤10,000,

more preferably 5≤[the particle diameter of the inorganic solid electrolyte particle]/[the particle diameter of the electron-insulating inorganic particle]≤8,000,

more preferably 5≤[the particle diameter of the inorganic solid electrolyte particle]/[the particle diameter of the electron-insulating inorganic particle]≤6,000,

more preferably 5≤[the particle diameter of the inorganic solid electrolyte particle]/[the particle diameter of the electron-insulating inorganic particle]≤4,000,

more preferably 5≤[the particle diameter of the inorganic solid electrolyte particle]/[the particle diameter of the electron-insulating inorganic particle]≤2,000,

more preferably 5≤[the particle diameter of the inorganic solid electrolyte particle]/[the particle diameter of the electron-insulating inorganic particle]≤1,000,

more preferably 10≤[the particle diameter of the inorganic solid electrolyte particle]/[the particle diameter of the electron-insulating inorganic particle]≤600,

more preferably 10≤[the particle diameter of the inorganic solid electrolyte particle]/[the particle diameter of the electron-insulating inorganic particle]≤400, and

it can be preferably 20≤[the particle diameter of the inorganic solid electrolyte particle]/[the particle diameter of the electron-insulating inorganic particle]≤300, and

more preferably 20≤[the particle diameter of the inorganic solid electrolyte particle]/[the particle diameter of the electron-insulating inorganic particle]≤200.

In the present invention, the “particle diameter” means the average primary particle diameter. This average primary particle diameter is a volume-based median diameter (d50).

The constitutional material of the electron-insulating inorganic particles is not particularly limited as long as it is an inorganic particle having electron-insulating properties. In the present invention, “electron-insulating properties” means that the electron conductivity is 10⁻⁹ S/cm or less at a measurement temperature of 25° C. Examples of the electron-insulating inorganic particle include aluminum oxide, silicon oxide, boron nitride, cerium oxide, diamond, and zeolite: however, the present invention is not limited thereto. The electron-insulating inorganic particle is preferably a metal oxide, and among the above, aluminum oxide is particularly preferable from the viewpoint of producing fine particles of about 50 nm with high purity and at low cost.

The content of the electron-insulating inorganic particles in the solid electrolyte membrane according to the embodiment of the present invention is preferably 5% to 45% by volume, more preferably 10% to 40% by volume, and still more preferably 20% to 30% by volume.

—Inorganic Solid Electrolyte Particle—

The inorganic solid electrolyte particles contained in the solid electrolyte membrane according to the embodiment of the present invention are inorganic particles having a Li ion conductivity, constituted of a material different from the electron-insulating inorganic particle. As described above, the particle diameter thereof is larger than that of the electron-insulating inorganic particles. The particle diameter of the inorganic solid electrolyte particles is preferably 0.1 μm or more, and it can be 0.5 μm or more. In addition, the particle diameter thereof is generally 200 μm or less, and it is preferably 100 μm or less.

Specifically, the preferred range of the particle diameter of the inorganic solid electrolyte particles is preferably 0.1 to 200 μm, more preferably 0.2 to 100 μm, still more preferably 0.4 to 80 μm, still more preferably 0.8 to 50 μm, and still more preferably 1 to 40 μm, and it can be 1 to 30 μm and preferably 1 to 20 μm.

Further, it is preferable that the inorganic solid electrolyte particles have electrolytic solution resistance. In a case where the inorganic solid electrolyte particles have electrolytic solution resistance, the inorganic solid electrolyte particles hardly cause side reactions, decomposition, and the like, even in a case of being used as a separator of a Li ion secondary battery in which the positive electrode layer or the negative electrode layer has an electrolytic solution. As such inorganic solid electrolyte particles, it is possible to preferably apply particles of the oxide-based inorganic solid electrolyte described below. The oxide-based inorganic solid electrolyte itself is known and is widely used as a solid electrolyte for an all-solid state secondary battery.

(Oxide-Based Inorganic Solid Electrolyte)

The oxide-based inorganic solid electrolyte contains an oxygen atom (O) and has a Li ion conductivity. The oxide-based inorganic solid electrolyte is preferably a compound having electron-insulating properties.

Specific examples of the compounds include LiₓₐLa_{ya}TiO₃ [xa=0.3 to 0.7 and ya=0.3 to 0.7] (LLT), Li_{xb}La_{yb}Zr_{zb}M^{bb}_{mb}O_{nb} (M^{bb} is at least one element of Al, Mg, Ca, Sr, V, Nb, Ta, Ti, Ge, In or Sn, xb satisfies 5≤xb≤10, yb satisfies 1≤≤yb≤4, zb satisfies 1≤zb≤4, mb satisfies 0≤mb≤2, and nb satisfies 5≤nb≤20.), Li_{xc}B_{yc}M^{cc}_{zc}O_{nc} (M^{cc} is at least one element of C, S, Al, Si, Ga, Ge, In, or Sn, xc satisfies 0≤xc≤5, yc satisfies 0≤yc≤1, zc satisfies 0≤zc≤1, and nc satisfies 0≤nc≤6), Li_{xd}(Al, Ga)_{yd}(Ti, Ge)_{zd}Si_{ad}P_{md}O_{nd} (1≤xd≤3, 0≤yd≤1, 0≤zd≤2, 0≤ad≤1, 1≤md≤7, 3≤nd≤13), Li_{(3.2xe)}M^{ee}ₓₑD^{ee}O (xe represents a number of 0 or more and 0.1 or less, M^{ee} represents a divalent metal atom, and D^{ee} represents a halogen atom or a combination of two or more halogen atoms), Li_{xf}Si_{yf}O_{zf} (1≤xf≤5, 0≤yf≤3, 1≤zf≤10), Li_{xg}S_{yg}O_{zg} (1≤xg≤3, 0≤yg≤2, 1≤zg≤10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w satisfies w<1), Li_{3.5}Zn_{0.25}GeO₄ having a lithium super ionic conductor (LISICON)-type crystal structure, La_{0.55}Li_{0.35}TiO₃ having a perovskite type crystal structure, LiTi₂P₃O₁₂ having a natrium super ionic conductor (NASICON)-type crystal structure, Li_{1+xh+yh}(Al, Ga)ₓₕ(Ti, Ge)₂₋ₓₕSi_{yh}P_{3-yh}O₁₂ (0≤xh≤1, 0≤yh≤1), and Li₇La₃Zr₂O₁₂ (LLZ) having a garnet-type crystal structure. In addition, a phosphorus compound containing Li, P, or O is also desirable. Examples thereof include lithium phosphate (Li₃PO₄) and LiPON in which a part of oxygen atoms in lithium phosphate are substituted with a nitrogen atom, LiPOD¹ (D¹ is at least one element selected from Ti, V, Cr, Mn, Fe, Co, Ni, Cu, Zr, Nb, Mo, Ru, Ag, Ta, W, Pt, Au, or the like). It is also possible to preferably use LiA¹ON (A¹ represents at least one element selected from Si, B, Ge, Al, C, Ga, or the like).

The content of the inorganic solid electrolyte particles in the solid electrolyte membrane according to the embodiment of the present invention is preferably 10% to 90% by volume, more preferably 20% to 80% by volume, still more preferably 30% to 70% by volume, and even still more preferably 40% to 60% by volume.

—Thermofused Solidified Product of Electron-Insulating Material—

The solid electrolyte membrane according to the embodiment of the present invention contains a thermofused solidified product of an electron-insulating material. The voids between the solid particles contained in the solid electrolyte membrane according to the embodiment of the present invention are in a state of being filled with the thermofused solidified product of the electron-insulating material. “In a state of being filled with the thermofused solidified product of the electron-insulating material” means that the electron-insulating material is present in the voids between the solid particles in accordance with the shape between the solid particles substantially without gaps, and the electron-insulating material present in the voids between the solid particles has been subjected to thermofusion (after thermofusion, it has been cooled and solidified). The electron-insulating material spreads in the voids between the solid particles in a thermofused state due to the capillary action and/or the pressure, and solidified in that state, whereby the voids between the solid particles can be filled with the thermofused solidified product of the electron-insulating material.

As the electron-insulating material, a material having such physical properties that it is solid at 100° C. (that is, it has a melting point of more than 100° C.) whereas is thermofuses in a temperature region of 200° C. or lower (that is, it has a melting point of 200° C. or lower) is used. “Solid at 100° C.” means it is solid at 100° C. under 1 atm. In addition, “thermofuses in a temperature region of 200° C. or less” means that it thermofuses in a temperature region of 200° C. or less at 1 atm. In a case where such an electron-insulating material is used, it is possible to easily heat the electron-insulating material to a temperature at which it thermofuses, during or after the layer formation using a mixture containing the electron-insulating inorganic particles, the inorganic solid electrolyte particles, and the electron-insulating material, and this heating makes it possible for thermofused filling material to be moved to the voids between the solid particles by the capillary action and/or pressure. Thereafter, cooling is carried out to solidify the electron-insulating material, whereby it is possible to obtain a state where thermofused solidified product of the electron-insulating material is embedded in accordance with the shape between the solid particles substantially without gaps.

The electron-insulating material is preferably a material having higher hardness than dendrite in a solid state in order to block dendrite growth. Examples thereof include sulfur, modified sulfur, iodine, a mixture of sulfur and iodine, and among them, sulfur and/or modified sulfur can be suitably used. Sulfur that can be used as the electron-insulating material means elemental sulfur (including sulfur existing as a multimer in addition to sulfur itself).

The modified sulfur is obtained by kneading sulfur and a modifier. For example, modified sulfur in which pure sulfur and an olefin compound as a modification additive are kneaded to partially modify sulfur into a sulfur polymer can be obtained. In a case where sulfur or modified sulfur is present as thermofused solidified product between the solid particles without gaps, it is possible to physically block the Li dendrites that have grown between the solid particles.

In addition, in a case where dendrites come into contact with sulfur, a reaction between Li dendrites and sulfur may also occur. It is conceived that in a case where Li dendrites of metallic lithium come into contact with sulfur, a reaction of 2Li+S→Li₂S occurs, and the growth of the Li dendrites stops. In a case where such a reaction occurs, a reaction product becomes to be present together between the solid particles. It is conceived that since the reaction product is an electron-insulating compound having higher hardness than the Li dendrite, the growth of the Li dendrite can be blocked. The reaction between Li dendrites and sulfur expands the volume of the electron-insulating material between the solid particles, whereby the effect of more reliably closing the voids remaining between the solid particles can be expected.

The content of thermofused solidified product of the electron-insulating material in the solid electrolyte membrane according to the embodiment of the present invention is preferably 5% to 45% by volume, more preferably 10% to 40% by volume, and still more preferably 20% to 30% by volume.

In the solid electrolyte membrane according to the embodiment of the present invention, an organic binder may be contained between the solid particles. As such an organic binder, an organic binder that is generally used in a solid electrolyte layer of a secondary battery can be appropriately employed.

<Manufacturing of Solid Electrolyte Membrane (Separator)>

The manufacturing method for a solid electrolyte membrane according to the embodiment of the present invention is not particularly limited as long as a solid electrolyte membrane that satisfies the specification of the present invention can be obtained. An example of the manufacturing method for a solid electrolyte membrane according to the embodiment of the present invention will be described below.

At least the electron-insulating inorganic particles, the inorganic solid electrolyte particles, and the electron-insulating material are kneaded to prepare a composition. This kneading temperature is preferably set to a temperature equal to or higher than thermofusion temperature of the electron-insulating material. Then, the kneaded material is stretched at a temperature equal to or higher than thermofusion temperature of the electron-insulating material by using a roller machine or the like to form a thin layer sheet having a thickness specified in the present invention. Then, cooling is carried out to solidify the electron-insulating material from thermofused state, whereby it is possible to obtain a solid electrolyte membrane in a state where the space between the solid particles is filled with the thermofused solidified product of the electron-insulating material.

The solidification of the electron-insulating material from thermofused state is preferably carried out under pressure. For example, in a case where thermofused product of the electron-insulating material is cooled to be solidified under a pressure of 100 MPa or more (preferably 140 MPa or more, more preferably 160 MPa or more, and still more preferably 200 MPa or more, and generally 1,000 MPa or less), it is possible to carry out solidification in a state where the amorphous state of thermofused electron-insulating material is sufficiently maintained. That is, it is possible to suppress the crystallization of thermofused solidified product of the electron-insulating material, with which the voids between the solid particles are filled, and it is possible to effectively suppress the generation of slight voids that can be a path for Li dendrites, the electrolytic solution, and the like.

The thickness of the solid electrolyte membrane of the present invention obtained in this manner is equal to or larger than [particle diameter of inorganic solid electrolyte particle×0.7] and equal to or smaller than [particle diameter of inorganic solid electrolyte particle×1.3]. Even in a case where the thickness of the solid electrolyte membrane is larger than the particle diameter of the inorganic solid electrolyte particle, since this “particle diameter” is the average primary particle diameter as described above, a sufficient number of inorganic solid electrolyte particles can be in contact with both the positive electrode and the negative electrode as one particle in a case where the thickness thereof is equal to or less than “particle diameter of inorganic solid electrolyte particle×1.3”. This makes it possible for Li ion conduction to be smoothly carried out.

From the viewpoint of further enhancing Li ion conductivity, the thickness of the solid electrolyte membrane is preferably [particle diameter of inorganic solid electrolyte particle×1.2] or less, and it can be preferably [particle diameter of inorganic solid electrolyte particle×1.15] or less, can be also preferably [particle diameter of inorganic solid electrolyte particle×1.1] or less, and can be also preferably [particle diameter of inorganic solid electrolyte particle×1.0] or less.

In the present invention, the thickness of the solid electrolyte membrane shall be a value obtained by measuring the thicknesses of the solid electrolyte membrane at 50 points at intervals of 10 μm in the cross section of the solid electrolyte membrane and arithmetically averaging them. The thickness can be measured by observing the cross section of the solid electrolyte membrane with a scanning electron microscope (SEM).

<Layer Constitution of Lithium Ion Secondary Battery>

The Li ion secondary battery according to the embodiment of the present invention includes various battery forms as described above as long as it has the solid electrolyte membrane according to the embodiment of the present invention as a separator. A preferred embodiment of the Li ion secondary battery according to the embodiment of the present invention will be described with reference to the drawings. In the drawings referred to below, the positive electrode collector and the negative electrode collector are omitted unless otherwise specified. It is noted that each drawing is a schematic view for facilitating the understanding of the present invention, and the magnitude of the size, the relative magnitude relationship, or the like of each member may be changed for the convenience of description, and it does not indicate the actual magnitude relationship as it is. Further, matters other than those specified in the present invention are not limited to the outer shape and the shape illustrated in these drawings.

### Embodiment-1

In a Li ion secondary battery of an embodiment-1 illustrated in FIG. 2, a semi-solid state shape positive electrode active material layer 21 containing an electrolytic solution is employed as the positive electrode active material layer. A solid electrolyte membrane 22 according to the embodiment of the present invention containing an inorganic solid electrolyte particle 25, electron-insulating inorganic particles 26, and a thermofused solidified product 27 of an electron-insulating material is provided in contact with the semi-solid state positive electrode active material layer 21, and a solid electrolyte layer 23 containing sulfide-based inorganic solid electrolyte particles is laminated in contact with the solid electrolyte membrane 22. This sulfide-based inorganic solid electrolyte has a small lithium ion capture action and a high Li ion conductivity as compared with the oxide-based inorganic solid electrolyte. On the other hand, the sulfide-based inorganic solid electrolyte causes a side reaction in a case of coming into contact with the electrolytic solution, and thus it may be easily decomposed.

In the embodiment-1, a negative electrode 24 of the metallic Li is provided on the solid electrolyte layer 23. Since the solid electrolyte layer 23 is provided between the metallic lithium negative electrode 24 and the solid electrolyte membrane 22, it is possible to obtain a battery having low contact resistance with the metallic Li negative electrode and having excellent Li dendrite resistance.

In addition to the sulfide-based inorganic solid electrolyte particles, the solid electrolyte layer 23 can contain various constitutional components that can be contained in the solid electrolyte layer of the general all-solid state secondary battery. Examples thereof include an organic binder such as an organic polymer and an ionic conductive auxiliary agent. Further, a form in which the space between the solid particles of the solid electrolyte layer 23 is filled with the thermofused solidified product of the electron-insulating material as in the solid electrolyte membrane 22 may be adopted.

In the embodiment-1, as described above, the semi-solid state positive electrode active material layer 21 containing the electrolytic solution is employed. On the other hand, the inorganic solid electrolyte particles 25 that constitutes the solid electrolyte membrane 22 in contact with the semi-solid state positive electrode active material layer 21 are constituted of an oxide-based inorganic solid electrolyte having electrolytic solution resistance. As a result, a form in which the solid electrolyte membrane 22 is directly laminated on the semi-solid state positive electrode active material layer 21 can be adopted. Further, in the solid electrolyte membrane 22, the voids between the solid particles are filled with thermofused solidified product 27 of the electron-insulating material without gaps, and the crystallization of the solidified product 27 is also suppressed. For this reason, it is possible to more reliably block the permeation of the electrolytic solution from the semi-solid state positive electrode active material layer 21 to the negative electrode side, and it is possible to suppress a side reaction of the sulfide-based inorganic solid electrolyte that constitutes the solid electrolyte layer 23 on the semi-solid state positive electrode active material layer 21 with the electrolytic solution.

Further, although the solid electrolyte membrane 22 is a thin separator in which inorganic solid electrolyte particles are disposed substantially in a single layer, it can effectively block Li dendrites that grow from the negative electrode.

In the embodiment-1, the semi-solid state positive electrode active material layer 21 is employed, and thus the positive electrode active material layer can be thickened. As a result, high energy density can be achieved. Further, the negative electrode is formed of metallic Li having a large theoretical capacity, which also contributes to high energy density.

The sulfide-based inorganic solid electrolyte that constitutes the solid electrolyte layer 23 will be described. The sulfide-based inorganic solid electrolyte itself is known, those that are widely used as a solid electrolyte for an all-solid state secondary battery can be used without particular limitation. The sulfide-based inorganic solid electrolyte preferably contains a sulfur atom (S), has an ion conductivity of a metal belonging to Group I or II of the periodic table, and has electron-insulating properties. It is preferable that sulfide-based inorganic solid electrolyte contains, as elements, at least Li, S, and P, and has a lithium ion conductivity; however, the sulfide-based inorganic solid electrolyte may also include elements other than Li, S, and P depending on the intended purpose.

Examples of the sulfide-based inorganic solid electrolyte include a lithium ion-conductive inorganic solid electrolyte satisfying the composition represented by Formula (I).

Lₐ₁M_{b1}P_{c1}S_{d1}Aₑ₁ Formula (I)

In the formula, L represents an element selected from Li, Na, and K and is preferably Li. M represents an element selected from B, Zn, Sn, Si, Cu, Ga, Sb, Al, or Ge. A represents an element selected from I, Br, Cl, or F, and a1 to e1 represent the compositional ratios between the respective elements, and a1:b1:c1:d1:e1 satisfies 1 to 12:0 to 5:1:2 to 12:0 to 10. Furthermore, a1 is preferably 1 to 9 and more preferably 1.5 to 7.5. b1 is preferably 0 to 3. Furthermore, d1 is preferably 2.5 to 10 and more preferably 3.0 to 8.5. Furthermore, e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio of Li₂S to P₂S₅ in Li—P—S-based glass and Li—P—S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase an ion lithium ion conductivity. Specifically, the ion conductivity of the lithium ion can be preferably set to 1×10⁻⁴ S/cm or more and more preferably set to 1×10⁻³ S/cm or more. The upper limit is not particularly limited but practically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S-Si_{S}2-P₂S₅—LiI, Li₂S—SiS₂—Li₄SiO₄, Li₂S—SiS₂—Li₃PO₄, and Li₁₀GeP₂S₁₂. The mixing ratio between the individual raw materials does not matter. Examples of the method of synthesizing a sulfide-based inorganic solid electrolyte material using the above-described raw material compositions include an amorphization method. Examples of the amorphorization method include a mechanical milling method, a solution method, and a melting quenching method. This because treatments at a normal temperature become possible, and it is possible to simplify manufacturing processes.

### Embodiment-2

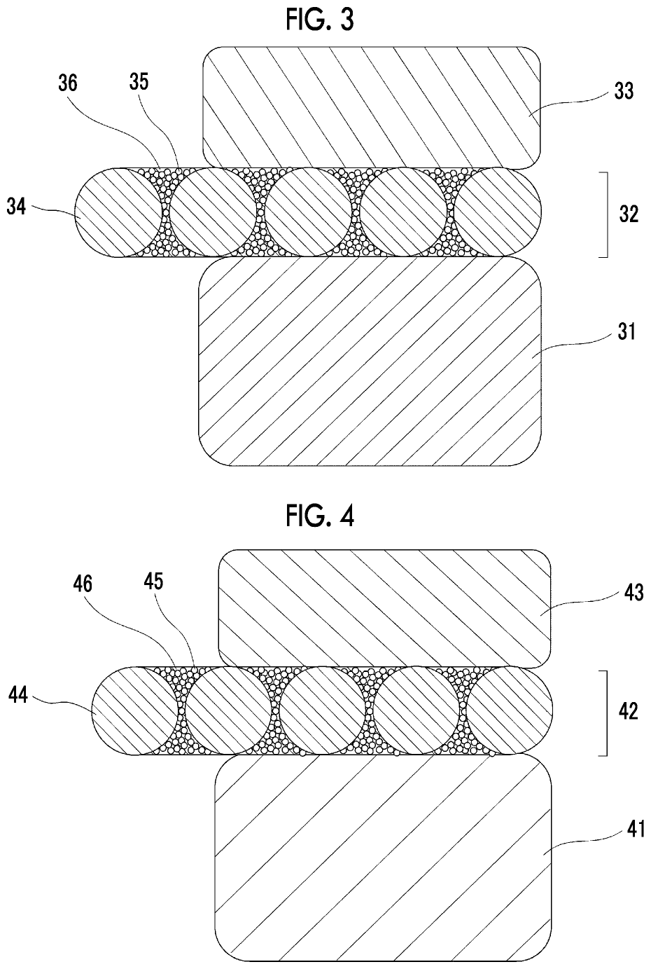

In a Li ion secondary battery of an embodiment-2 illustrated in FIG. 3, a semi-solid state positive electrode active material layer 31 and a solid electrolyte membrane 32 are the same as the semi-solid state positive electrode active material layer 21 and the solid electrolyte membrane 22 of the embodiment-1, respectively. In the embodiment-2, a semi-solid state negative electrode active material layer 33 containing an electrolyte is disposed on the negative electrode side of the solid electrolyte membrane 32, in contact with the solid electrolyte membrane 32.

In the embodiment-2, the solid electrolyte membrane according to the embodiment of the present invention is disposed as a separator between the positive and negative electrodes, and although it is a thin separator in which inorganic solid electrolyte particles are disposed substantially in a single layer, it can effectively block Li dendrites that grow from the negative electrode.

In the embodiment-2, the semi-solid state positive electrode active material layer 31 and the semi-solid state negative electrode active material layer 33 are employed, and thus both electrode active material layers can be thickened. As a result, high energy density can be achieved. Further, the electrolytic solution of the semi-solid state positive electrode active material layer 31 and the electrolytic solution of the semi-solid state negative electrode active material layer 33 are separated by the solid electrolyte membrane 32 and thus are not mixed with each other. For this reason, the electrolytic solution of the semi-solid state positive electrode active material layer 31 and the electrolytic solution of the semi-solid state negative electrode active material layer 33 can be made to be electrolytic solutions different from each other. This extends the range of choices of active materials that are used in the positive and negative electrodes.

### Embodiment-3

An embodiment-3 illustrated in FIG. 4 is a so-called all-solid state Li ion secondary battery. A solid electrolyte membrane 42 according to the embodiment of the present invention is disposed as an inorganic solid electrolyte layer that is disposed between a positive electrode active material layer 41 and a negative electrode active material layer 43. The solid electrolyte membrane 42 is the same as the solid electrolyte membrane 22 of the embodiment-1.

### Embodiment-4

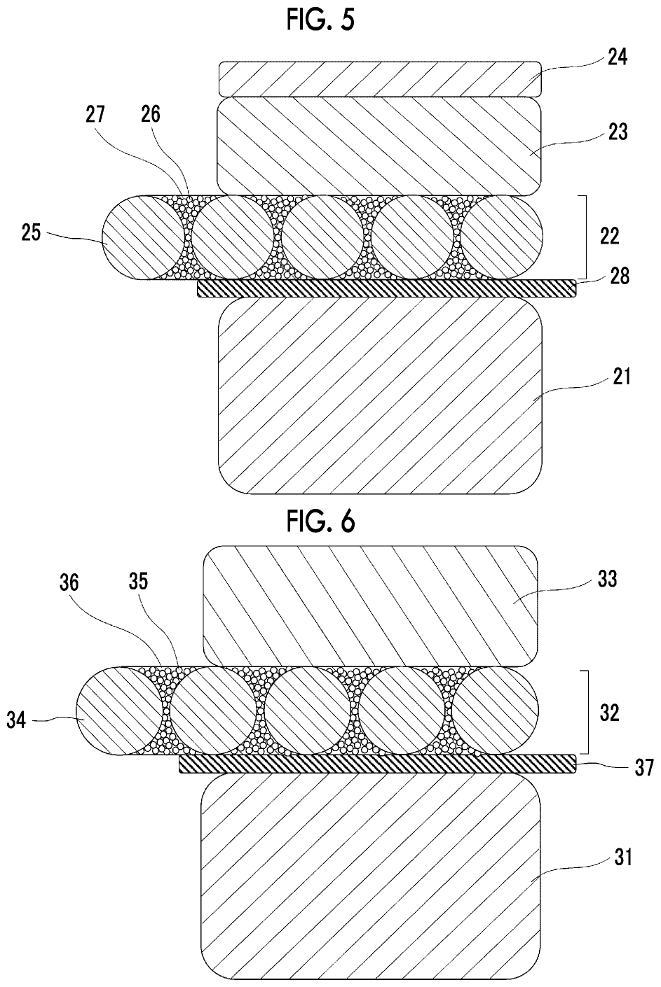

A Li ion secondary battery of an embodiment-4 illustrated in FIG. 5 has a constitution in which a separator sheet 28 is further disposed between the semi-solid state positive electrode active material layer 21 and the solid electrolyte membrane 22 in the embodiment-1. As the separator sheet 28, a separator generally used in an electrolytic solution-type Li ion secondary battery can be widely applied. Examples of the constitutional material of the separator sheet 28 include a porous polymer material, an inorganic material, an organic-inorganic hybrid material, and glass fiber. The volume proportion occupied by the gaps of the separator sheet 28, that is, the void volume is preferably 20% to 90% and more preferably 35% to 80%.

Examples of the polymer material include cellulose non-woven fabric, polyethylene, and polypropylene, and a separator sheet obtained by using these in combination can also be used. It is also preferably a polymer material obtained by laminating two or more kinds of microporous films having different pore diameters, void volumes, pore closing temperatures.

Examples of the inorganic material include oxides such as alumina and silicon dioxide; nitrides such as aluminum nitride and silicon nitride; and sulfates such as barium sulfate and calcium sulfate.

In a case where the separator sheet 28 is further disposed between the semi-solid state positive electrode active material layer 21 and the solid electrolyte membrane 22, it is possible to prevent a state where thermofused solidified products (sulfur) or the like of the positive electrode active material, the conductive auxiliary agent, and the electron-insulating material are present together in the presence of the electrolytic solution from being formed, and it is possible to prevent a side reaction between the positive electrode active material or the conductive auxiliary agent and thermofused solidified product (sulfur) of the electron-insulating material.

### Embodiment-5

A Li ion secondary battery of an embodiment-5 illustrated in FIG. 6 has a constitution in which a separator sheet 37 is further disposed between the semi-solid state positive electrode active material layer 31 and the solid electrolyte membrane 32 in the embodiment-2. The separator sheet 37 is the same as the separator sheet 28 described in the embodiment-4.

In a case where the separator sheet 37 is further disposed between the semi-solid state positive electrode active material layer 31 and the solid electrolyte membrane 32, it is possible to prevent a state where thermofused solidified products (sulfur) or the like of the positive electrode active material, the conductive auxiliary agent, and the electron-insulating material are present together in the presence of the electrolytic solution from being formed, and it is possible to prevent a side reaction between the positive electrode active material or the conductive auxiliary agent and thermofused solidified product (sulfur) of the electron-insulating material.

### Embodiment-6

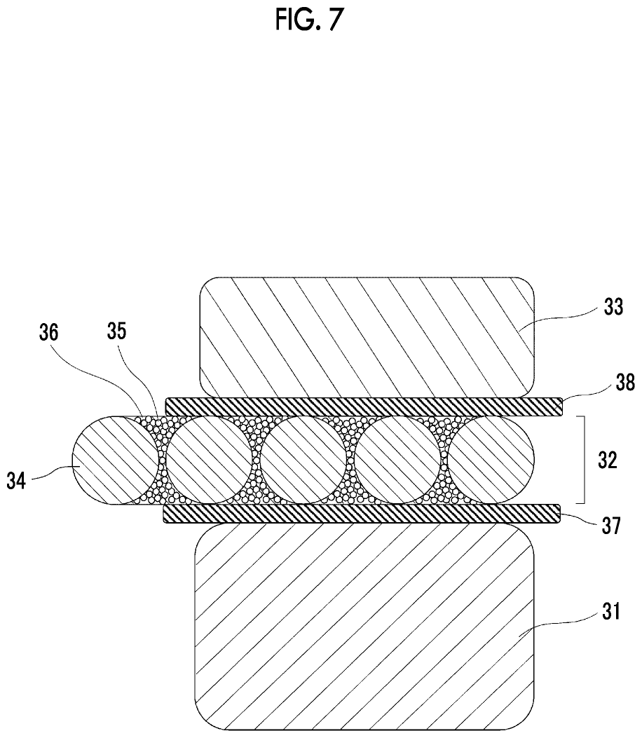

A Li ion secondary battery of an embodiment-6 illustrated in FIG. 7 has a constitution in which a separator sheet 37 is further disposed between the semi-solid state positive electrode active material layer 31 and the solid electrolyte membrane 32 in the embodiment-2, and a separator sheet 38 is also disposed between the solid electrolyte membrane 32 and the semi-solid negative electrode active material layer 33. The separator sheet 37 and the separator sheet 38 are the same as the separator sheet 28 described in the embodiment-4.

In a case where the separator sheet 37 is further disposed between the semi-solid state positive electrode active material layer 31 and the solid electrolyte membrane 32, it is possible to prevent a state where thermofused solidified products (sulfur) or the like of the positive electrode active material, the conductive auxiliary agent, and the electron-insulating material are present together in the presence of the electrolytic solution from being formed, and it is possible to prevent a side reaction between the positive electrode active material or the conductive auxiliary agent and thermofused solidified product (sulfur) of the electron-insulating material.

Similarly, in a case where the separator sheet 38 is further disposed between the semi-solid state negative electrode active material layer 33 and the solid electrolyte membrane 32, it is possible to prevent a state where thermofused solidified products (sulfur) or the like of the negative electrode active material, the conductive auxiliary agent, and the electron-insulating material are present together in the presence of the electrolytic solution from being formed, and it is possible to prevent a side reaction between the negative electrode active material or the conductive auxiliary agent and thermofused solidified product (sulfur) of the electron-insulating material.

Although the preferred embodiments of the Li ion secondary battery according to the embodiment of the present invention have been described with reference to the drawings, the present invention is not limited to these embodiments except for the matters specified in the present invention. For example, the Li ion secondary battery according to the embodiment of the present invention may have a plurality of solid electrolyte membranes according to the embodiment of the present invention. For example, the solid electrolyte membrane according to the embodiment of the present invention can be laminated in two layers and used as a separator.

<Use Application of Lithium Ion Secondary Battery>

The lithium ion secondary battery according to the embodiment of the present invention can be applied to a variety of use applications. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a portable tape recorder, a radio, and a backup power supply, and a memory card. Additionally, examples of the consumer usage thereof include an automobile, an electric vehicle, a motor, a lighting instrument, a toy, a game device, a road conditioner, a watch, a strobe, a camera, and a medical device (a pacemaker, a hearing aid, a shoulder massage device, and the like). Furthermore, the all-solid state secondary battery can be used for a variety of military usages and universe usages. In addition, the all-solid state secondary battery can also be combined with a solar battery.

Among them, it is preferably applied to an application that requires high capacity and high rate discharging characteristics. For example, in power storage equipment of which the capacity is expected to increase in the future, high safety is indispensable, and further compatibility with battery performance is required. In addition, a high-capacity secondary battery is mounted on electric vehicles and the like, and thus use applications for daily charging at home are considered. According to the present invention, it is possible to exhibit excellent effects in suitable response to such usage patterns.

### EXAMPLES

The present invention will be described in more detail based on Examples; however, the present invention is not limited to these embodiments.

### Example 1

### <Example 1-1> Preparation of Solid Electrolyte Membrane (Separator)

Mixing was carried out at a ratio of 50% by volume of LLZ (Li₇La₃Zr₂O₁₂, particle diameter: 3.0 μm, manufactured by TOSHIMA manufacturing Co., Ltd.) as an oxide-based inorganic solid electrolyte, 25% by volume of Al₂O₃(particle diameter: 50 nm, manufactured by SkySpring Nanomaterials, Inc), and 25% by volume of sulfur (S, manufactured by Sigma-Aldrich Co., LLC, Purity: >99.98%), and the resultant mixture was kneaded at 140° C. In a state of being sandwiched between two aluminum foils, the kneaded material was stretched by roll pressing at 160 MPa with a roller machine heated to 150° C., whereby a sheet in which the thickness excluding the aluminum foil was 3.5 μm was produced. This sheet was subjected to hot pressing with hot water under conditions of 160° C. and 550 MPa and then cooled to obtain a solid electrolyte membrane of Example 1-1. The thickness of the obtained solid electrolyte membrane was 3.0 μm.

### <Example 1-2> Preparation of Li Ion Secondary Battery

<Production of Positive Electrode Sheet>

180 zirconia beads having a diameter of 5 mm was put into a 45 mL container made of zirconia (manufactured by FRITSCH), and the following materials were further put into the container, and 2.0 g of LPS (a sulfide-based inorganic solid electrolyte) synthesized according to the method described in [Reference Example] of WO2018/164051A, 0.1 g of styrene butadiene rubber (product code: 182907, manufactured by Sigma-Aldrich Co., LLC), and 22 g of octane as a dispersion medium were put thereinto. Thereafter, the container was set in a planetary ball mill P-7 (trade name) manufactured by FRITSCH, stirring was carried out at a temperature of 25° C. and a rotation speed of 300 rpm for two hours Thereafter, 7.9 g of the positive electrode active material LiNi_{0.85}Co_{0.10}Al_{0.05}O₂ (lithium nickel cobalt aluminum oxide) was placed into the container, the container was set again in the planetary ball mill P-7, and mixing was continued at a temperature of 25° C. and a rotation speed of 100 rpm for 15 minutes. In this manner, a positive electrode composition was obtained.

Next, the positive electrode composition obtained as described above was applied on an aluminum foil having a thickness of 20 the aluminum foil serving as an electrode collector, with a baker type applicator, and then the positive electrode composition was dried by heating at 80° C. for 2 hours. Then, using a heat press machine, the composition for a positive electrode layer, which had been dried to have a predetermined density, was pressurized (600 MPa, 1 minute) while being heated (120° C.). In this manner, a positive electrode sheet having a positive electrode active material layer with a film thickness of 110 μm was produced.

The positive electrode sheet was overlaid on the surface of the solid electrolyte membrane of Example 1-1 so that the positive electrode active material layer was in contact with the surface of the solid electrolyte membrane. Further, a lithium foil was overlaid on the side of the solid electrolyte membrane opposite to the positive electrode sheet side. A restraining plate serving as a restraining member and a screw were used to the laminate, the tightening force of the screw was adjusted with a torque wrench to set the restraining force to 8 MPa, and then an all-solid state Li ion secondary battery of Example 1-2 was obtained.

### Example 2

### <Example 2-1> Preparation of Solid Electrolyte Membrane (Separator)

A solid electrolyte membrane (thickness: 8.5 μm) of Example 2-1 was obtained in the same manner as in Example 1-1, except that in Example 1-1, the particle diameter of the LLZ to be used was changed to 8.0 μm.

### <Example 2-2> Preparation of Li Ion Secondary Battery

Using the solid electrolyte membrane of Example 2-1, an all-solid state Li ion secondary battery of Example 2-2 was obtained in the same manner as in Example 1-2.

### Comparative Example 1

### <Comparative Example 1-1> Preparation of Solid Electrolyte Membrane (Separator)

Mixing was carried out at a ratio of 50% by volume of LLZ (Li₇La₃Zr₂O₁₂, particle diameter: 3.0 μm, manufactured by TOSHIMA manufacturing Co., Ltd.) as an oxide-based inorganic solid electrolyte, 25% by volume of Al₂O₃ (particle diameter: 500 nm, manufactured by SkySpring Materials, Inc), and 25% by volume of sulfur (S, manufactured by Sigma-Aldrich Co., LLC, Purity: >99.98%), and the resultant mixture was kneaded at 140° C. In a state of being sandwiched between two aluminum foils, the kneaded material was stretched by roll pressing at 24 MPa with a roller machine heated to 150° C., whereby a sheet in which the thickness excluding the aluminum foil was 100 μm was produced. The obtained sheet was cooled and the aluminum foil was peeled off to obtain a solid electrolyte membrane of Comparative Example 1-1.

### <Comparative Example 1-2> Preparation of Li Ion Secondary Battery

Using the solid electrolyte membrane of Comparative Example 1-1, an all-solid state Li ion secondary battery of Comparative Example 1-2 was obtained in the same manner as in Example 1-2.

### Comparative Example 2

### <Comparative Example 2-1> Preparation of Solid Electrolyte Membrane (Separator)

A solid electrolyte membrane (thickness: 100 μm) of Comparative Example 2-1 was obtained in the same manner as in Comparative Example 1-1, except that in Comparative Example 1-1, Al₂O₃ (the same as that of Example 1-1) having a particle diameter of 50 nm was used.

### <Comparative Example 2-2> Preparation of Li Ion Secondary Battery

Using the solid electrolyte membrane of Comparative Example 2-1, an all-solid state Li ion secondary battery of Comparative Example 1-2 was obtained in the same manner as in Example 1-2.

### Comparative Example 3

### <Comparative Example 3-1> Preparation of Solid Electrolyte Membrane (Separator)

A solid electrolyte membrane (thickness: 3.5 μm) of Comparative Example 3-1 was obtained in the same manner as in Example 1-1, except that in Example 1-1, stretching by roll pressing was carried out at 150° C. and 24 MPa, and hot pressing with hot water was not carried out.

### <Comparative Example 3-2> Preparation of Li Ion Secondary Battery

Using the solid electrolyte membrane of Comparative Example 3-1, an all-solid state Li ion secondary battery of Comparative Example 3-2 was obtained in the same manner as in Example 1-2.

### Test Example

<Evaluation of State of Thermofused Solidified Product of Sulfur>

By the above-described Raman microscope spectroscopy, it was examined whether thermofused solidified product of sulfur with which the space between the solid particles was filled was in an amorphous state or a crystallized state.

<Evaluation of Charging and Discharging Cycle Characteristics>

Charging and discharging was carried out using each of the all-solid state Li ion secondary batteries produced above under the following conditions, and the charging and discharging cycle characteristic test was carried out. One charging operation and one subsequent discharging operation was set as one cycle.

(Conditions)

30° C., current density: 0.09 mA/cm² (equivalent to 0.05 C), 4.2 V, charging and discharging at constant current conditions (0.36 m A/cm²)

In a case where the internal short circuit occurred, the charging was not completed, and thus the charging was completed at a time of 50 hours, and then discharging was carried out. The presence or absence of the internal short circuit was determined based on the presence or absence of the drastic voltage drop during charging.

The charging and discharging cycle characteristics were evaluated based on the following evaluation standards.

—Evaluation Standards for Charging and Discharging Cycle Characteristics—

A: No short circuit occurs even after 3 cycles or more.

B: Short circuit occurs after 2 cycles or more and less than 3 cycles.

C: Short circuit occurs after 1 cycle or more and less than 2 cycles.

D: Short circuit occurs before 1 cycle is completed.

The results are shown in the table below.

TABLE 1

| | | | Comparative | Comparative | Comparative |
|---|---|---|---|---|---|
| | Example1 | Example2 | Example1 | Example2 | Example3 |
| Sulfur state | Amorphous | Amorphous | Crystal | Crystal | Crystal |
| (Amorphous/Crystal) | | | | | |
| Charging and | A | A | B | B | D |
| discharging cycle | | | | | |
| characteristics | | | | | |

As shown in the above table, although the solid electrolyte membrane according to the embodiment of the present invention is formed to have an ultrathin membrane shape in which inorganic solid electrolyte particles are disposed substantially to be a single layer, which suppresses battery resistance, the Li ion secondary battery using this solid electrolyte membrane as a separator has excellent charging and discharging cycle characteristics.

The solid electrolyte membrane according to the embodiment of the present invention uses an inorganic solid electrolyte having electrolyte resistance. As a result, it can be seen that the solid electrolyte membrane according to the embodiment of the present invention can be applied as a separator regardless of the form of the Li ion secondary battery such as the electrolytic solution-type secondary battery or the all-solid state secondary battery and can further enhance the cycle characteristics of the Li ion secondary battery while suppressing the battery resistance of the Li ion secondary battery to be obtained.

The present invention has been described together with the embodiments of the present invention. However, the inventors of the present invention do not intend to limit the present invention in any part of the details of the description unless otherwise specified, and it is conceived that the present invention should be broadly construed without departing from the spirit and scope of the invention shown in the attached “WHAT IS CLAIMED IS”.

### EXPLANATION OF REFERENCES

10: all-solid state secondary battery
1: negative electrode collector
2: negative electrode active material layer
3: solid electrolyte layer
4: positive electrode active material layer
5: positive electrode collector
6: operation portion
21, 31: semi-solid state positive electrode active material layer
22, 32, 42: solid electrolyte membrane (separator)
23: solid electrolyte layer (sulfide-based inorganic solid electrolyte-containing layer)
24: metallic lithium layer (Li foil)
25, 34, 44: inorganic solid electrolyte particle
26, 35, 45: electron-insulating inorganic particle
27, 36, 46: thermofused solidified product of electron-insulating material
28, 37, 38: separator sheet
33: semi-solid state negative electrode active material layer
41: all-solid state positive electrode active material layer
43: all-solid state negative electrode active material layer

What is claimed is:

1. A lithium ion secondary battery comprising:
a solid electrolyte membrane having an electron-insulating inorganic particle having a particle diameter of 10 to 500 nm, an inorganic solid electrolyte particle having a particle diameter larger than a particle diameter of the electron-insulating inorganic particle and having electrolytic solution resistance and ion conductivity, and a thermofused solidified product of an electron-insulating material that is solid at 100° C. and thermofuses in a temperature region of 200° C. or lower, with which a void between the particles is filled;
a positive electrode layer disposed on one side of the solid electrolyte membrane;
a negative electrode layer disposed on a side of the solid electrolyte membrane opposite to the one side, where the positive electrode layer is disposed; and
wherein the thermofused solidified product of the electron-insulating material is in an amorphous state, and
a thickness of the solid electrolyte membrane is equal to or larger than [the particle diameter of the inorganic solid electrolyte particle×0.7] and equal to or smaller than [the particle diameter of the inorganic solid electrolyte particle×1.3].

2. The lithium ion secondary battery according to claim 1,
wherein a positive electrode active material layer that constitutes the positive electrode layer contains an electrolytic solution, and the thickness of the positive electrode active material layer is 2.00 to 2,000 μm.

3. The lithium ion secondary battery according to claim 1,
wherein a negative electrode active material that constitutes the negative electrode layer contains metallic lithium.

4. The lithium ion secondary battery according to claim 1,
wherein the entire negative electrode layer is constituted of a metallic lithium layer and has a sulfide-based inorganic solid electrolyte layer between the metallic lithium layer and the solid electrolyte membrane.

5. The lithium ion secondary battery according to claim 1,
wherein a negative electrode active material layer that constitutes the negative electrode layer contains an electrolytic solution.

6. The lithium ion secondary battery according to claim 1,
wherein the lithium ion secondary battery is an all-solid state lithium ion secondary battery.

7. The lithium ion secondary battery according to claim 1,
wherein the electron-insulating material contains sulfur.

8. The lithium ion secondary battery according to claim 7,
wherein the electron-insulating material is at least one of sulfur or modified sulfur.

9. The lithium ion secondary battery according to claim 1,
wherein the particle diameter of the electron-insulating inorganic particle and the particle diameter of the inorganic solid electrolyte particle satisfy the following formula,
5≤[the particle diameter of the inorganic solid electrolyte particle]/[the particle diameter of the electron-insulating inorganic particle].

10. A solid electrolyte membrane for a lithium ion secondary battery, comprising:
an electron-insulating inorganic particle having a particle diameter of 10 to 500 nm;
an inorganic solid electrolyte particle having a particle diameter larger than a particle diameter of the electron-insulating inorganic particle and having electrolytic solution resistance and ion conductivity; and
a thermofused solidified product of an electron-insulating material that is solid at 100° C. and thermofuses in a temperature region of 200° C. or lower, with which a void between the particles is filled,
wherein the thermofused solidified product of the electron-insulating material is in an amorphous state, and
a thickness of the solid electrolyte membrane is equal to or larger than [the particle diameter of the inorganic solid electrolyte particle×0.7] and equal to or smaller than [the particle diameter of the inorganic solid electrolyte particle×1.3].

11. The solid electrolyte membrane for a lithium ion secondary battery according to claim 10,
wherein the electron-insulating material contains sulfur.

12. The solid electrolyte membrane for a lithium ion secondary battery according to claim 11,
wherein the electron-insulating material is at least one of sulfur or modified sulfur.

13. A manufacturing method for the solid electrolyte membrane for a lithium ion secondary battery according to claim 1, the manufacturing method comprising:
forming a layer, in which the electron-insulating material thermofuses, using a composition containing an electron-insulating inorganic particle having a particle diameter of 10 to 500 nm, an inorganic solid electrolyte particle having a particle diameter larger than a particle diameter of the electron-insulating inorganic particle and having electrolytic solution resistance and Li ion conductivity; and the electron-insulating material that is solid at 100° C. and thermofuses in a temperature region of 200° C. or lower; and
solidifying a thermofused product of the electron-insulating material under a pressure of 100 MPa or more.

14. A manufacturing method for a lithium ion secondary battery, comprising disposing the solid electrolyte membrane for a lithium ion secondary battery according to claim 1 between a positive electrode and a negative electrode.
